(19) United States
(12) Patent Application Publication
(10) Pub. No.: US 2026/0307616 A1
(43) Pub. Date: Oct. 8, 2026

(54) SEAT BELT MOUNTING STRUCTURE OF VEHICLE BODY

(71) Applicants: Hyundai Motor Company, Seoul (KR); Kia Corporation, Seoul (KR)

(72) Inventors: Hae Hoon Lee, Hwaseong-si (KR); Jin-oh Kim, Hwaseong-si (KR); Byeongkyu Kwon, Hwaseong-si (KR); Dong Wook Kim, Hwaseong-si (KR); Hyejin Yang, Hwaseong-si (KR)

(21) Appl. No.: 19/404,296

(22) Filed: Dec. 1, 2025

(30) Foreign Application Priority Data
Apr. 2, 2025 (KR) 10-2025-0042552
May 26, 2025 (KR) 10-2025-0068130

(51) Int. Cl. B60R 22/24; B60R 22/34

(52) U.S. Cl. CPC B60R 22/24; B60R 22/34; B60R 2022/3402

(57) ABSTRACT

A seat belt mounting structure for a vehicle body includes a roof side connected to an upper portion of a quarter pillar positioned on the side of the vehicle body, a gusset assembly connected to a pillar connecting portion of the roof side to mount a retractor of a seat belt assembly, and a transverse direction roof rail connected to the gusset assembly along the vehicle width direction.

### CROSS-REFERENCE TO RELATED APPLICATIONS

This application claims priority to and the benefit of Korean Patent Application No. 10-2025-0042552 filed with the Korean Intellectual Property Office on Apr. 2, 2025, and Korean Patent Application No. 10-2025-0068130 filed with the Korean Intellectual Property Office on May 26, 2025, the entire contents of which are incorporated herein by reference.

### TECHNICAL FIELD

The disclosed embodiment relates to a vehicle body, and more particularly, the present disclosure relates to a seat belt mounting structure mounted to the vehicle body.

### BACKGROUND

Recently, the vehicle industry has been introducing a new concept of a future mobility vision for realizing a dynamic, human-centered future city. One of these future mobility solutions is a purpose-based mobility (e.g., a Purpose Built Vehicle (PBV)).

A PBV is an example of an electric vehicle (EV)-based, environment-friendly mobility vehicle. PBVs can provide users with a variety of customized services during travel from departure to destination.

A PBV can be manufactured in various shapes and sizes depending on the user's use case. For example, A PBV can be used as a hailing or delivery type vehicle.

To provide users with a wide and convenient boarding and disembarking space, a hailing vehicle applies a sliding door to the side structure of the PBV vehicle body. The PBV is equipped with a seat belt assembly mounted on the vehicle body as a safety component to prevent occupant accidents in the event of a collision or rollover.

The seat belt assembly may be mounted, in one example, to the upper portion of a rear pillar (e.g., a D pillar) of the vehicle body and to the rear roof rail, at positions corresponding to the rear seat rows.

If the rear roof rail has a closed cross-section structure, the mounting strength of the seat belt assembly may be increased, however, the cost and weight may increase. If the rear roof rail has an opened cross-section structure, cost and weight can be reduced, but because the mounting strength of the seat belt assembly is weak, reinforcing materials are required to reinforce the mounting strength of the seat belt assembly.

In another example, the seat belt assembly may be mounted between the upper portion of a rear pillar of the vehicle body and the upper portion of a quarter pillar (e.g., a C pillar positioned forward of the rear pillar).

However, even in such cases, reinforcing materials mounted on the upper portion of the rear pillar and the upper portion of the quarter pillar are required to reinforce the mounting strength of the seat belt assembly.

In another example, a hailing vehicle may apply a ramp device as a wheelchair boarding device for the transportation disadvantaged. Wheelchair passengers can board the vehicle through the open part of the sliding door to the rear of the vehicle interior by means of a ramp device.

Because the wheelchair occupant's seating position is higher, it may be difficult for the wheelchair occupant to fasten the seat belt if the seat belt assembly is mounted on the lower side of the quarter pillar.

Therefore, it is necessary to adjust the mounting position of the seat belt assembly so that the wheelchair occupant can easily wear the seat belt.

The information contained in this background section is intended to enhance understanding of the background of the invention and may include matters that are not conventional art already known to a person of ordinary skill in the field to which this technology belongs.

### SUMMARY

The present disclosure attempts to provide a seat belt mounting structure of a vehicle body that enhances the mounting strength of the seat belt assembly and minimizes the application of reinforcing materials to enhance the mounting strength of the seat belt assembly.

Additionally, the disclosure attempts to provide a seat belt mounting structure for a vehicle body that allows a wheelchair occupant to easily wear a seat belt by mounting the seat belt assembly to an upper portion of a quarter pillar.

A seat belt mounting structure for a vehicle body according to the disclosed embodiment may include a roof side connected to an upper portion of a quarter pillar positioned on the side of the vehicle body, a gusset assembly connected to a pillar connecting portion of the roof side to mount a retractor of a seat belt assembly, and a transverse direction roof rail connected to the gusset assembly along the vehicle width direction.

The seat belt mounting structure according to the disclosed embodiment may further include longitudinal direction roof rails that are arranged parallel to the front-rear direction of the vehicle body on the upper portion of the vehicle body and are connected to the gusset assembly and the transverse direction roof rail.

The seat belt mounting structure according to the disclosed embodiment may further include a joint bracket connected to the gusset assembly, the transverse direction roof rail and the longitudinal direction roof rails.

A pocket for mounting the retractor may be formed in the gusset assembly.

A closed section may be formed between the gusset assembly, the transverse direction roof rail and the joint bracket, which are joined together.

The closed section may be connected to the pocket along vehicle width direction.

A seat belt mounting structure for a vehicle body according to the disclosed embodiment may include a roof side connected to an upper portion of a quarter pillar positioned on the side of the vehicle body, a gusset assembly including a main gusset unit connected to a pillar connecting portion of the roof side to mount a retractor of a seat belt assembly, and an extension gusset unit connected to the main gusset unit along the vehicle width direction, a transverse direction roof rail connected to the extension gusset unit along the vehicle width direction, and longitudinal direction roof rails arranged parallel to the front-rear direction of the vehicle body on the upper portion of the vehicle body and connected to the extension gusset unit and the transverse direction roof rail.

The seat belt mounting structure according to the disclosed embodiment may further include a joint bracket connected to the extension gusset unit, the transverse direction roof rail and the longitudinal direction roof rails.

The main gusset unit may include a lower gusset member connected to a pillar connecting portion and connected to the retractor, and an upper gusset member connected to the pillar connecting portion and connected to the upper portion of the lower gusset member.

The extension gusset unit may include a lower extension member connected to the lower gusset member along the vehicle width direction and connected to the longitudinal direction roof rails and the transverse direction roof rail, and an upper extension member connected to the upper gusset member and the lower extension member along the vehicle width direction.

The seat belt mounting structure according to the disclosed embodiment may further include a pocket is formed between the lower gusset member and the upper gusset member, and between the lower extension member and the upper extension member.

The seat belt mounting structure according to the disclosed embodiment may further include a joint bracket connected to the lower extension member, the transverse direction roof rail and the longitudinal direction roof rails.

The retractor may be disposed in the pocket through a mount hole formed in the lower gusset member and connected to the edge of the mount hole.

A connection portion of the lower gusset member and the lower extension member may be formed as a gusset overlapping portion.

A connecting portion of the lower extension member connected to the longitudinal direction roof rails and the transverse direction roof rail may be formed as a roof rail overlapping portion.

The retractor may be disposed in a mount hole formed in the lower gusset member and mounted to the lower gusset member and the gusset overlapping portion along the edge portion of the mount hole.

The joint bracket may be connected to the lower extension member, the transverse direction roof rail, and the longitudinal direction roof rails. A closed section may be formed between the lower extension member, the transverse direction roof rail and the joint bracket, which are joined together. The closed section may be connected to the pocket along the vehicle width direction.

Each of the longitudinal direction roof rails may include a first roof rail member connected to a front roof rail disposed along the vehicle width direction at the front of both sides of the vehicle body, and a second roof rail member connected to a rear roof rail disposed along the vehicle width direction at the rear of both sides of the vehicle body.

Each of the first roof rail member and the second roof rail member may include rail forming parts formed on free end portions facing each other and connected to the connecting portion of the lower extension member and the transverse direction roof rail.

The roof side, the gusset assembly, the transverse direction roof rail, the longitudinal direction roof rails, and the joint bracket may be connected to the roof panel.

According to the seat belt mounting structure of the vehicle body according to the disclosed embodiment, the mounting strength of the seat belt assembly mounted on the upper portion of the quarter pillar can be strengthened. According to the seat belt mounting structure of the vehicle body according to the disclosed embodiment, the use of reinforcing materials to reinforce the mounting strength of the seat belt assembly can be minimized or eliminated.

According to the seat belt mounting structure of the vehicle body according to the disclosed embodiment, the seat belt assembly can be mounted on the upper portion of the quarter pillar in a vehicle to which a ramp device for the transportation vulnerable is applied. According to the seat belt mounting structure of the vehicle body according to the disclosed embodiment, a wheelchair passenger can easily wear a seat belt.

In addition, any effects that can be obtained or expected from the disclosed embodiment are disclosed directly or implicitly in the detailed description of the disclosed embodiment. That is, various effects expected according to the disclosed embodiment will be disclosed in the detailed description that follows.

### BRIEF DESCRIPTION OF THE DRAWINGS

These drawings are intended for reference in describing exemplary embodiments disclosed, and therefore the technical ideas of the disclosed embodiments should not be construed as limited to the accompanying drawings.

FIG. 1 is a partially exploded perspective view illustrating a vehicle body to which a seat belt mounting structure according to the disclosed embodiment may be applied.

FIG. 2 is a top plan view illustrating a seat belt mounting structure of a vehicle body according to the disclosed embodiment.

FIGS. 3 and 4 are perspective views illustrating a seat belt mounting structure of a vehicle body according to the disclosed embodiment.

FIGS. 5 and 6 are exploded perspective views illustrating a seat belt mounting structure of a vehicle body according to the disclosed embodiment.

FIG. 7 is a perspective view illustrating a main gusset unit of a gusset assembly applied to a seat belt mounting structure of a vehicle body according to the disclosed embodiment.

FIG. 8 is a cross-sectional view along line A-A of FIG. 4.

FIG. 9 is an exploded perspective view illustrating an extension gusset unit of a gusset assembly applied to a seat belt mounting structure of a vehicle body according to the disclosed embodiment.

FIG. 10 is a cross-sectional view along the B-B line of FIG. 4.

FIG. 11 is an exploded perspective view illustrating a joint bracket applied to a seat belt mounting structure of a vehicle body according to the disclosed embodiment.

FIG. 12 is a cross-sectional view along the C-C line of FIG. 4.

FIG. 13 is a cross-sectional view along line D-D of FIG. 4.

FIG. 14 is a perspective view illustrating an example of a mount of a seat belt assembly applied to a seat belt mounting structure of a vehicle body according to the disclosed embodiment.

### DESCRIPTION OF SYMBOLS

1: vehicle body

3: side structure

4a: front pillar

4b: center pillar

4c: rear pillar

5: quarter pillar

6: roof structure

6a: front roof rail

6b: rear roof rail

7: roof panel

8: seat belt assembly

8a: seat belt

9: retractor

10: roof side

11: pillar connecting portion

20: gusset assembly

21: main gusset unit

23: lower gusset member

25: upper gusset member

27: lower flange

29: lower forming part

31: mount hole

33: upper flange

35: upper forming part

41: extension gusset unit

43: lower extension member

45: upper extension member

47: first part

49: second part

51: pocket

53: fastening member

55: gusset overlapping portion

57: closed section

59: connecting section

60: transverse direction roof rail

70: longitudinal direction roof rail

71: first roof rail member

71a, 72a: free end portion

71b, 72b: rail forming part

72: second roof rail member

73: roof rail overlapping portion

80: joint bracket

81: first joint flange

83: second joint flange

85: joint forming part

LP1, LP2: load path

100: seat belt mounting structure

The drawings referenced above are not necessarily drawn to scale, but should be understood as presenting rather simplified representations of various features that illustrate the basic principles of the disclosed embodiments. For example, certain design features of the disclosed embodiments, including specific dimensions, direction, position, and shape, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that a person having ordinary skill in the art to which the present invention pertains can practice the present invention. As those skilled in the art would understand, the described embodiments may be modified in various different ways, all without departing from the spirit or scope of the present invention.

The terminology used herein is for the purpose of describing particular embodiments only, and is not intended to limit the present disclosure. As used herein, the singular forms are intended to include the plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term 'and/or' includes any and all combinations of one or more of the associated listed items.

In this specification, the term ‘connected’ indicates a physical relationship between two components where the components are directly connected to each other (e.g., by welding, SPR (Self Piercing Rivet), FDS (Flow Drill Screw), structural adhesive, etc.,) or indirectly connected through one or more intermediate components.

As used herein, 'vehicle', 'vehicular', 'automotive' or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources).

Hereinafter, embodiments of the present disclosure will be described in detail with reference to the attached drawings.

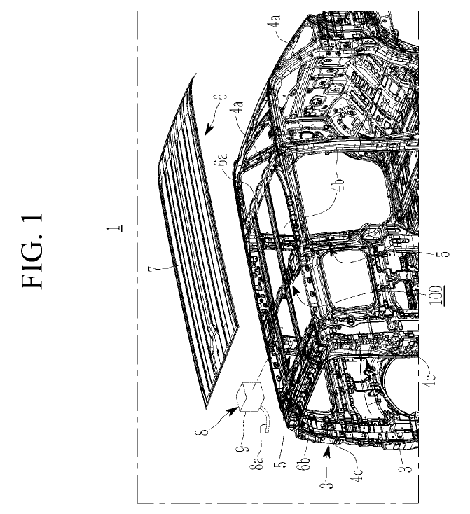

FIG. 1 is a partially exploded perspective view illustrating a vehicle body to which a seat belt mounting structure according to the disclosed embodiment may be applied.

Referring to FIG. 1, a seat belt mounting structure 100 of a vehicle body according to the disclosed embodiment can be applied, for example, to a vehicle body 1 of a purpose-based mobility vehicle (Purpose Built Vehicle: hereinafter referred to as ‘PBV’).

The PBV may be utilized as an electric vehicle-based life module vehicle that provides various customized services to users during the time they travel from the departure point to the destination.

In one example, the PBV may be manufactured as a one box type design with a wide vehicle interior space. The PBV may also apply facing-type seats to the vehicle interior space. The vehicle body of the PBV may be manufactured in various shapes and sizes depending on the purpose and/or use of the PBV.

The vehicle body of the PBV may be utilized as a variety of vehicle types, such as, for example, a hailing vehicle used as a means of transporting occupants, a delivery vehicle for transporting goods, and a special vehicle such as an ambulance.

In this disclosure, the reference direction for describing the components below may be set as the vehicle body front-back direction (e.g., vehicle body length direction or longitudinal direction), vehicle width direction (e.g., lateral direction or left-right direction), and vertical direction (e.g., height direction) with the vehicle body as reference.

In this specification, the ‘top’, ‘upper’, or ‘upper face’ of a component refers to an end, section, or face of the component that is relatively higher in the drawing, and the ‘bottom’, ‘lower’, or ‘lower face’ of a component refers to an end, section, or face of the component that is relatively lower in the drawing.

In this disclosure, the term "end" of a component (e.g., one end, the other end, or both ends, etc.) refers to an end of the component in any one direction, and the term "end portion" of a component (e.g., one end portion, the other end portion, both end portions, the front end portion, or the rear end portion, etc.) refers to a portion of the component that includes that end.

The vehicle body 1 of the PBV may include a side structure 3 arranged on each side along the vehicle width direction, and a roof structure 6 connected to the upper portion of the side structure 3.

The side structure 3 may be equipped with a vehicle door (not shown), such as a sliding door or swing door. The side structure 3 may include a front pillar 4a, a center pillar 4b, a quarter pillar 5, and a rear pillar 4c.

The front pillar 4a, the center pillar 4b, the quarter pillar 5, and the rear pillar 4c are defined for ease of understanding and may be the A pillar, B pillar, C pillar, and D pillar used in the industry.

The roof structure 6 may be connected to the upper portion of the side structure 3. The roof structure 6 may include a roof panel 7. The roof structure 6 may include a high roof module.

As an example, the vehicle body 1 of the PBV may be used as a hailing vehicle that may transport a wheelchair user with reduced mobility through the sliding door opening between the center pillar 4b and the quarter pillar 5.

A seat belt assembly 8 may be mounted on the side structure 3. The seat belt assembly 8 may, in one example, be mounted at a position corresponding to a row of rear seats within the vehicle. The seat belt assembly 8 may, in another example, be mounted in a position corresponding to the shoulder of a wheelchair occupant.

The seat belt assembly 8 may include a retractor 9 for winding or releasing a seat belt 8a. The configuration and operation of the seat belt assembly 8 are obvious to those skilled in the art, so a detailed description is omitted.

The seat belt mounting structure 100 of the vehicle body according to the disclosed embodiment is configured to mount the seat belt assembly 8 on the side structure 3 of the vehicle body 1.

The seat belt mounting structure 100 of the vehicle body according to the disclosed embodiment may provide a structure that does not require reinforcing materials to reinforce the mounting strength of the seat belt assembly 8.

The seat belt mounting structure 100 of the vehicle body according to the disclosed embodiment may provide a structure that mounts the seat belt assembly 8 to the upper part of the quarter pillar 5 so that a wheelchair occupant may easily wear the seat belt 8a.

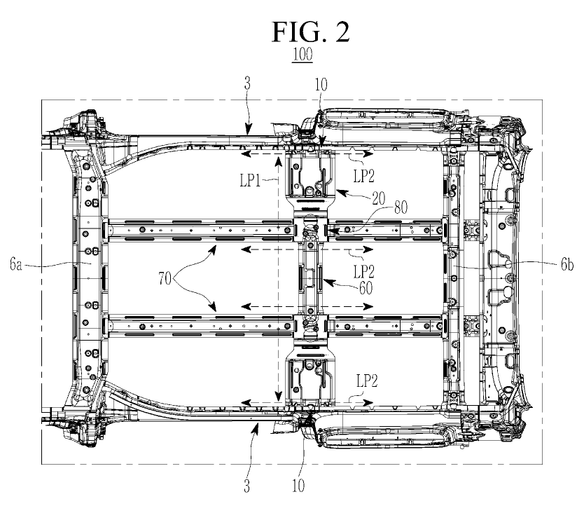

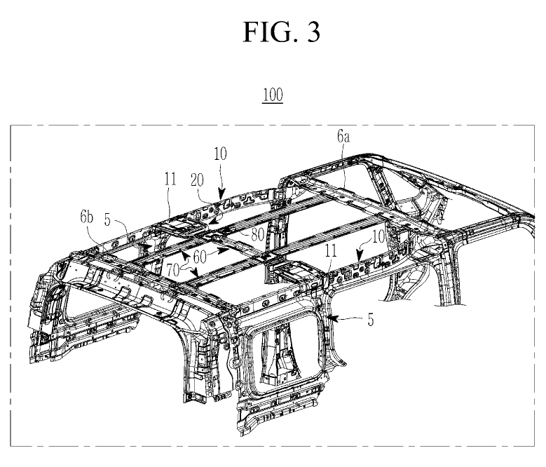

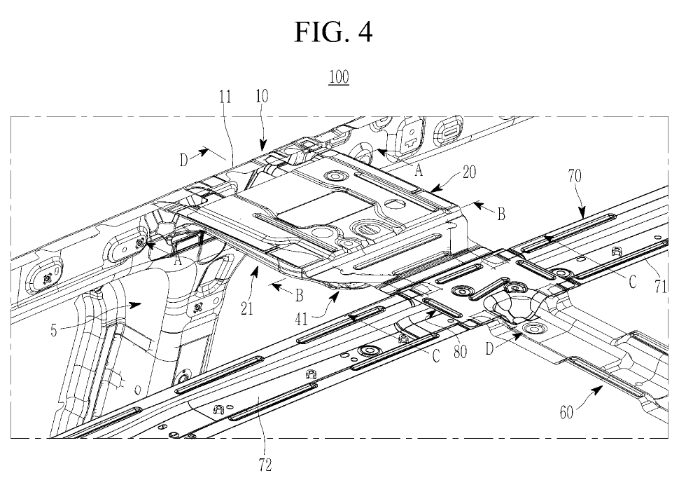

FIG. 2 is a top plan view illustrating a seat belt mounting structure of a vehicle body according to the disclosed embodiment, and FIGS. 3 and 4 are perspective views illustrating a seat belt mounting structure of a vehicle body according to the disclosed embodiment.

Referring to FIGS. 1 to 4, the seat belt mounting structure 100 of the vehicle body according to the disclosed embodiment may include a roof side 10, a gusset assembly 20, a transverse direction roof rail 60, longitudinal direction roof rails 70, and a joint bracket 80.

In the disclosed embodiment, the roof side 10 may be provided on the upper portion of the side structure 3. The roof side 10 may be arranged along the front-rear direction of the vehicle body and may be connected to the upper portions of the front pillar 4a, the center pillar 4b, the quarter pillar 5, and the rear pillar 4c.

The roof side 10 may be connected to the roof panel 7 of the roof structure 6.

In the disclosed embodiment, the gusset assembly 20 mounts the retractor 9 of the seat belt assembly 8 and is configured to reinforce the mounting strength of the retractor 9.

The gusset assembly 20 may be connected to a pillar connecting portion 11 of the roof side 10, which is connected to the upper portion of the quarter pillar 5 in the disclosed embodiment.

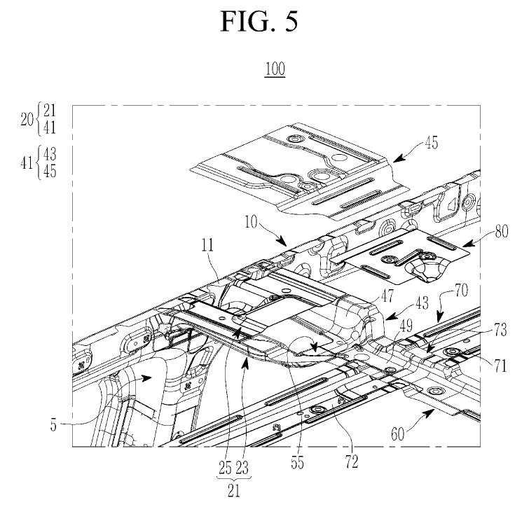

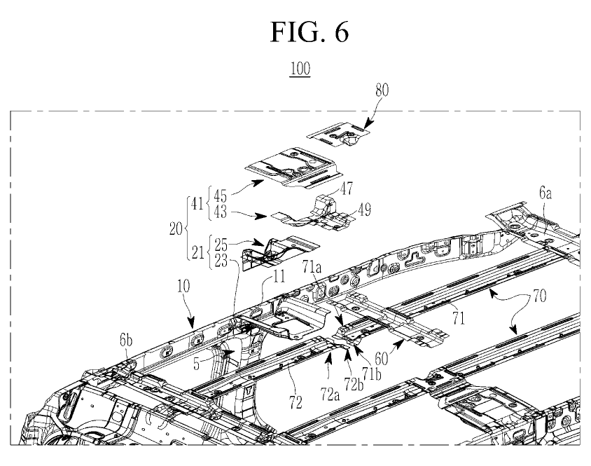

FIGS. 5 and 6 are exploded perspective views illustrating a seat belt mounting structure of a vehicle body according to the disclosed embodiment.

Referring to FIGS. 4 to 6, in the disclosed embodiment, the gusset assembly 20 may include a main gusset unit 21 and an extension gusset unit 41.

The main gusset unit 21 may be connected to the pillar connecting portion 11 of the roof side 10 along the vehicle width direction.

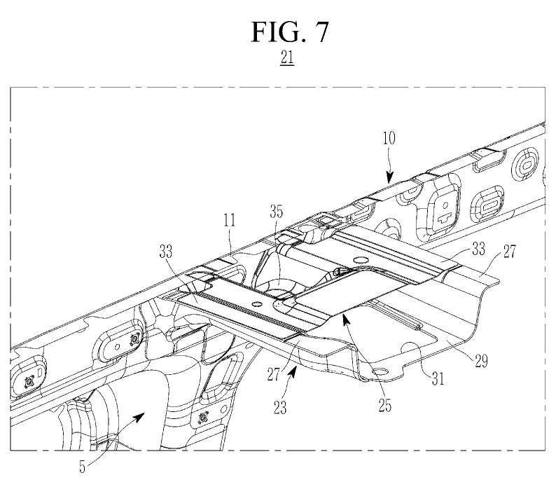

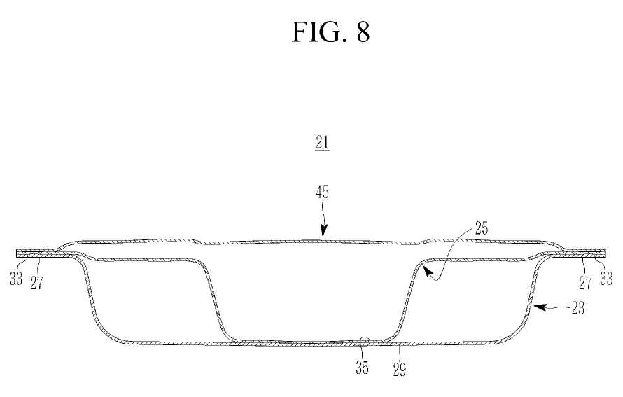

FIG. 7 is a perspective view illustrating a main gusset unit of a gusset assembly applied to a seat belt mounting structure of a vehicle body according to the disclosed embodiment, and FIG. 8 is a cross-sectional view along line A-A of FIG. 4.

The main gusset unit 21 may include a lower gusset member 23 and an upper gusset member 25, as shown in FIGS. 7 and 8.

The lower gusset member 23 may be connected to the pillar connecting portion 11 of the roof side 10 along the vehicle width direction, and may be connected to the retractor 9 as shown in FIG. 1.

The lower gusset member 23 may include a lower flange 27 formed on each side along the front-rear direction of the vehicle body, and a lower forming part 29 formed downward from the lower flange 27.

The lower forming part 29 may have a mount hole 31 formed to mount the retractor 9 to the gusset assembly 20.

The upper gusset member 25 may be connected to the pillar connecting portion 11 of the roof side 10 along the vehicle width direction, and may be connected to the upper portion of the lower gusset member 23.

The upper gusset member 25 may include an upper flange 33 formed on each side along the front-rear direction of the vehicle body, and an upper forming part 35 formed downward from the upper surface between the upper flanges 33.

The upper flange 33 may be connected to the lower flange 27 of the lower gusset member 23. The upper forming part 35 may be connected to the lower forming part 29 of the lower gusset member 23.

The extension gusset unit 41 may be connected to the main gusset unit 21 along the vehicle width direction.

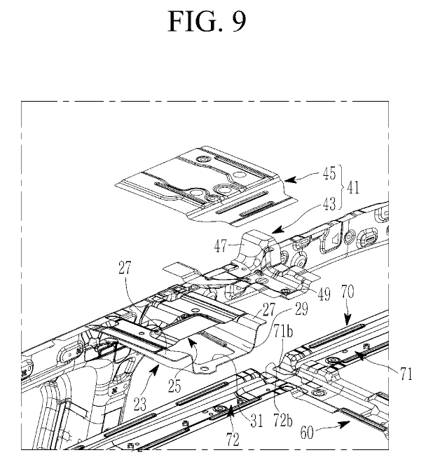

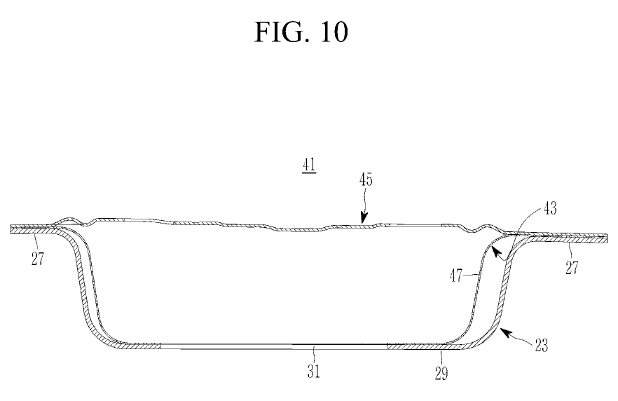

FIG. 9 is an exploded perspective view illustrating an extension gusset unit of a gusset assembly applied to a seat belt mounting structure of a vehicle body according to the disclosed embodiment, and FIG. 10 is a cross-sectional view along the B-B line of FIG. 4.

As shown in FIGS. 9 and 10, the extension gusset unit 41 may include a lower extension member 43 and an upper extension member 45.

The lower extension member 43 may be connected to the lower gusset member 23 along the vehicle width direction.

The lower extension member 43 may include a first part 47 that may be connected to a portion of the lower gusset member 23, and a second part 49 that may be connected to the transverse direction roof rail 60 and longitudinal direction roof rails 70, which is described below.

The first part 47 may be connected to the edge of the mount hole 31 in the lower gusset member 23. The first part 47 may be connected to the lower flange 27 and lower forming part 29 at the edge of the mount hole 31.

The second part 49 may extend along the vehicle width direction from the first part 47 with a width smaller than that of the first part 47. The second part 49 may be formed into a shape formed downward on both sides along the front-rear direction of the vehicle body.

The upper extension member 45 may be connected to the upper gusset member 25 and the lower extension member 43 along the vehicle width direction.

The upper extension member 45 may be connected to the upper part of the upper gusset member 25 and the first part 47 of the lower extension member 43.

Referring to FIGS. 4 to 6, in the disclosed embodiment, the transverse direction roof rail 60 may be provided as a component of the roof structure 6 (see FIG. 1)

The transverse direction roof rail 60 may be connected to the gusset assembly 20 provided on both sides of the vehicle body 1 along the vehicle width direction.

The transverse direction roof rail 60 may be connected to the extension gusset unit 41 of the gusset assembly 20 along the vehicle width direction. The two ends of the transverse direction roof rail 60 may be connected to the second part 49 of the lower extension member 43 in the extension gusset unit 41 as shown in FIG. 9.

The transverse direction roof rail 60 may be provided in the form of an opened cross-section formed downward on both sides along the front-rear direction of the vehicle body.

Referring to FIG. 5, FIGS. 6 and 9, in the disclosed embodiment, the longitudinal direction roof rails 70 may be provided as another component of the roof structure 6.

The longitudinal direction roof rails 70 may be arranged parallel to the front-rear direction of the vehicle body on the upper portion of the vehicle body 1, and may be connected to the gusset assembly 20 and the transverse direction roof rail 60.

The longitudinal direction roof rails 70 may, in one example, be provided with two spines arranged parallel along the front-rear direction of the vehicle body. The longitudinal direction roof rails 70 may be connected at right angles to the extension gusset unit 41 and the transverse direction roof rail 60.

Each of the longitudinal direction roof rails 70 may include a first roof rail member 71 and a second roof rail member 72.

The first roof rail member 71 may be connected along the front-rear direction of the vehicle body to a front roof rail 6a connected along the vehicle width direction to both sides of the vehicle body 1, e.g., the front of the side structure 3.

The second roof rail member 72 may be connected to a rear roof rail 6b, which is connected to the rear of the side structure 3 along the vehicle width direction, along the front-rear direction of the vehicle body.

The first roof rail member 71 and the second roof rail member 72 may be spaced apart from each other, for example, along the front-rear direction of the vehicle body. The spaced ends of the first roof rail member 71 and the second roof rail member 72 may be defined as free end portions 71aand 72a.

Each of the first roof rail member 71 and the second roof rail member 72 may include rail forming parts 71b and 72b formed on the free end portions 71a and 72a facing each other.

The rail forming parts 71b and 72b may be connected to the second part 49 of the lower extension member 43 and both ends of the transverse direction roof rail 60. That is, the connection portion of the lower extension member 43 and the transverse direction roof rail 60 may be connected to the rail forming parts 71b and 72b.

The connection portion of the lower extension member 43 and the transverse direction roof rail 60 may be formed as a roof rail overlapping portion 73. The roof rail overlapping portion 73 may be connected in three layers with the rail forming parts 71b and 72b of the first roof rail member 71 and the second roof rail member 72.

Referring to FIGS. 4 to 6, in the disclosed embodiment, the joint bracket 80 is configured to connect the gusset assembly 20, the transverse direction roof rail 60 and the longitudinal direction roof rails 70.

The joint bracket 80 may be configured to reinforce the connection strength of the gusset assembly 20, the transverse direction roof rail 60 and the longitudinal direction roof rails 70.

The joint bracket 80 may be connected to the extension gusset unit 41 of the gusset assembly 20, the transverse direction roof rail 60, and the longitudinal direction roof rails 70 connected in a right-angled direction.

The joint bracket 80 may be connected to the second part 49 of the lower extension member 43, a part of the upper extension member 45, both ends of the transverse direction roof rail 60, and the longitudinal direction roof rails 70.

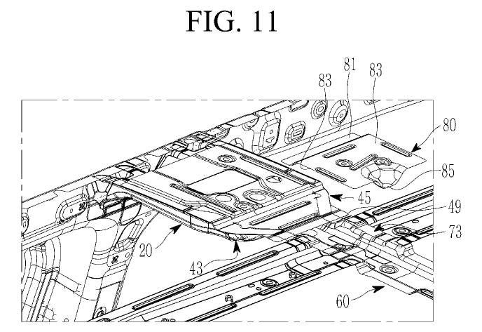

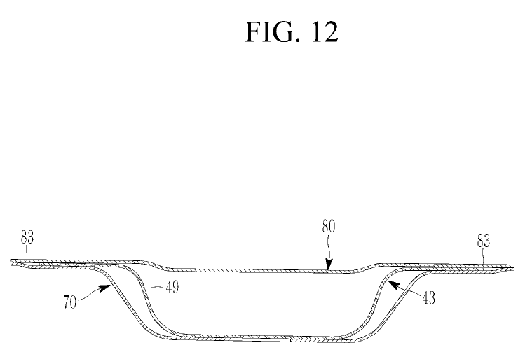

FIG. 11 is an exploded perspective view illustrating a joint bracket applied to a seat belt mounting structure of a vehicle body according to the disclosed embodiment, and FIG. 12 is a cross-sectional view along the C-C line of FIG. 4.

As shown in FIGS. 11 and 12, the joint bracket 80 may include a first joint flange 81, a second joint flange 83, and a joint forming part 85.

The first joint flange 81 may be formed on one side of the joint bracket 80 along the vehicle width direction and may be connected to a portion of the upper extension member 45.

The second joint flange 83 may be formed on each side of the joint bracket 80 along the front-rear direction of the vehicle body, and may be connected to longitudinal direction roof rails 70.

The joint forming part 85 may be formed on the other side of the joint bracket 80 along the vehicle width direction. The joint forming part 85 may be formed into a shape formed from the upper surface to the lower surface between the second joint flanges 83.

In the joint bracket 80, the upper surface between the second joint flange 83 may be connected to the second part 49 of the lower extension member 43 and both ends of the transverse direction roof rail 60, which are joined to each other. The joint forming part 85 may be connected to the lower formed portion at both ends of the transverse direction roof rail 60.

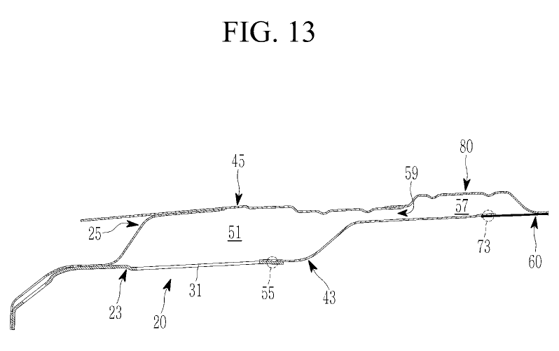

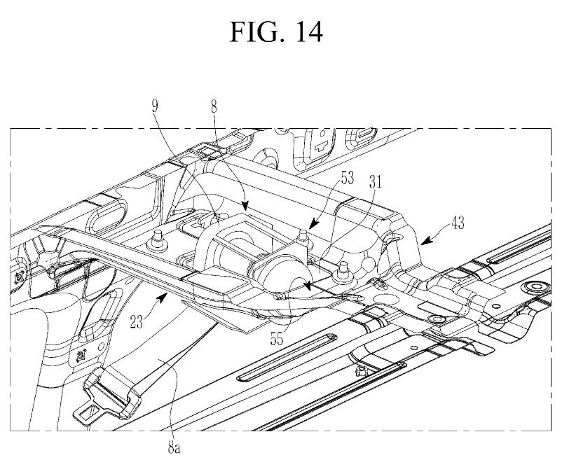

FIG. 13 is a cross-sectional view along line D-D of FIGS. 4 and 14 is a perspective view illustrating an example of a mount of a seat belt assembly applied to a seat belt mounting structure of a vehicle body according to the disclosed embodiment.

Referring to FIGS. 4, 5 and 13, the gusset assembly 20 according to the disclosed embodiment may include a pocket 51.

The pocket 51 may be configured to mount the retractor 9 of the seat belt assembly 8 as shown in FIG. 14.

The pocket 51 may be formed between the lower gusset member 23 and the upper gusset member 25, and between the lower extension member 43 and the upper extension member 45.

The pocket 51 may be connected to the mount hole 31 formed in the lower gusset member 23. That is, the pocket 51 may be formed as a retractor mount space connected to the mount hole 31.

The retractor 9 may be placed in the pocket 51 through the mount hole 31 of the lower gusset member 23, and may be connected to the edge portion of the mount hole 31. The retractor 9 may be engaged at the edge of the mount hole 31 by a fastening member 53, for example a bolt and a nut.

In the gusset assembly 20 forming the pocket 51, the connection portion of the lower gusset member 23 and the lower extension member 43 may be formed as a gusset overlapping portion 55.

The retractor 9 may be placed in the pocket 51 through the mount hole 31 of the lower gusset member 23, and may be engaged by the fastening member 53 to the lower gusset member 23 and the gusset overlapping portion 55 along the edge portion of the mount hole 31.

Referring to FIGS. 11 and 13, a closed section 57 may be formed between the gusset assembly 20, the transverse direction roof rail 60 and the joint bracket 80, which are joined together.

The closed section 57 may be formed between the lower extension member 43, both ends of the transverse direction roof rail 60, and the joint bracket 80. The closed section 57 may be formed between the roof rail overlapping portion 73 and the joint bracket 80.

Closed section 57 may be connected to the pocket 51 along the vehicle width direction.

A connecting section 59 may be formed between the connecting portion of the joint bracket 80 and the upper extension member 45, and the lower extension member 43. The connecting section 59 may be positioned between the pocket 51 and the closed section 57, and may be connected to the pocket 51 and the closed section 57 along the vehicle width direction.

The assembly process and operation of the seat belt mounting structure 100 of the vehicle body according to the disclosed embodiment will be described in detail referring to FIGS. 1 to 14.

In the disclosed embodiment, the side structures 3 are provided that are coupled to both sides of the floor structure along the vehicle width direction. The side structure 3 includes the front pillar 4a, the center pillar 4b, the quarter pillar 5, and the rear pillar 4c.

In the disclosed embodiment, the roof side 10 is connected to the upper portion of the front pillar 4a, the center pillar 4b, the quarter pillar 5, and the rear pillar 4c along the front-rear direction of the vehicle body.

At the front of the roof side 10, the front roof rail 6a may be connected along the vehicle width direction. At the rear of the roof side 10, the rear roof rail 6b may be connected along the vehicle width direction.

The front roof rail 6a may have the first roof rail member 71 of the longitudinal direction roof rails 70 connected along the front-rear direction of the vehicle body. The rear roof rail 6b may have the second roof rail member 72 connected along the front-rear direction of the vehicle body.

The facing rail forming parts 71b and 72b of the first roof rail member 71 and the second roof rail member 72 may be connected to both ends of the transverse direction roof rail 60.

In this state, a first assembly process of joining the lower gusset member 23 and the upper gusset member 25 of the main gusset unit 21 to the pillar connecting portion 11 of the roof side 10 may be performed.

In the first assembly process, the lower gusset member 23 may be connected to the pillar connecting portion 11 along the vehicle width direction. The upper gusset member 25 may be connected to the pillar connecting portion 11 along the vehicle width direction, and may be connected to the lower flange 27 of the lower gusset member 23 via the upper flange 33. The upper forming part 35 of the upper gusset member 25 may be connected to the lower forming part 29 of the lower gusset member 23.

A second assembly process may be performed to join the lower extension member 43 and the upper extension member 45 of the extension gusset unit 41 to the main gusset unit 21 and the longitudinal direction roof rails 70.

In the second assembly process, the first part 47 of the lower extension member 43 may be connected to the lower flange 27 and lower forming part 29 of the lower gusset member 23 along the vehicle width direction. The first part 47 may be connected to the edge of the mount hole 31 formed in the lower gusset member 23. The second part 49 of the lower extension member 43 may be connected to the rail forming parts 71b and 72b of the longitudinal direction roof rails 70 and both ends of the transverse direction roof rail 60.

In the second assembly process, the upper extension member 45 may be connected to the upper part of the upper gusset member 25 and the first part 47 of the lower extension member 43 along the vehicle width direction.

The assembly of the gusset assembly 20, which combines the main gusset unit 21 and the extension gusset unit 41, may be completed by the first assembly process and the second assembly process.

The extension gusset unit 41 of the gusset assembly 20, the transverse direction roof rail 60 and the longitudinal direction roof rails 70 may be connected in the vertical direction. Inside the gusset assembly 20, the pocket 51 connected to the mount hole 31 and the connecting section 59 connected to the pocket 51 along the vehicle width direction may be formed.

A third assembly process may be performed to attach the joint bracket 80 to the extension gusset unit 41 of the gusset assembly 20, the transverse direction roof rail 60 and the longitudinal direction roof rails 70 connected in the cross direction.

In the third assembly process, the joint bracket 80 may be connected to the upper extension member 45 through the first joint flange 81 and to the longitudinal direction roof rails 70 through the second joint flange 83. The joint bracket 80 may be connected to the lower extension member 43 through the upper surface between the second joint flange 83, and may be connected to both ends of the transverse direction roof rail 60 through the joint forming part 85. The closed section 57 may be formed between the extension gusset unit 41, the transverse direction roof rail 60 and the joint bracket 80, which are joined together. The closed section 57 may be connected to the pocket 51 along the vehicle width direction via the connecting section 59.

A fourth assembly process may be performed to mount the retractor 9 of the seat belt assembly 8 into the pocket 51 of the gusset assembly 20.

In the fourth assembly process, the retractor 9 may be placed in the pocket 51 through the mount hole 31 of the lower gusset member 23. The retractor 9 may be engaged with the lower gusset member 23 and the gusset overlapping portion 55 along the edge portion of the mount hole 31 by the fastening member 53.

After the fourth assembly process is completed, the roof panel 7 of the roof structure 6 may be connected to the front roof rail 6a, the rear roof rail 6b, the roof side 10, the gusset assembly 20, the transverse direction roof rail 60, the longitudinal direction roof rails 70, and the joint bracket 80.

According to the seat belt mounting structure 100 of the vehicle body according to the disclosed embodiment, the gusset assembly 20 may be connected to the pillar connecting portion 11 of the roof side 10 connected to the upper portion of the quarter pillar 5.

According to the seat belt mounting structure 100 of the vehicle body according to the disclosed embodiment, the gusset assembly 20 may be connected to the longitudinal direction roof rails 70, and the transverse direction roof rail 60 may be connected to the gusset assembly 20 and the longitudinal direction roof rails 70.

According to the seat belt mounting structure 100 of the vehicle body according to the disclosed embodiment, the joint bracket 80 is connected to the longitudinal direction roof rails 70 and may be connected to the gusset assembly 20 and the transverse direction roof rail 60.

According to the seat belt mounting structure 100 of the vehicle body according to the disclosed embodiment, the retractor 9 of the seat belt assembly 8 is positioned in the pocket 51 of the gusset assembly 20 and may engage the gusset assembly 20.

The gusset assembly 20, the transverse direction roof rail 60, and the longitudinal direction roof rails 70 may be connected along the vehicle width direction by the joint bracket 80. The pocket 51, the connecting section 59 and the closed section 57 may be connected along the vehicle width direction formed by the gusset assembly 20, the transverse direction roof rail 60 and the longitudinal direction roof rails 70

That is, the cross-sections of the pocket 51, the connecting section 59 and the closed section 57 may be connected along the vehicle width direction.

Accordingly, the seat belt mounting structure 100 of the vehicle body according to the disclosed embodiment may form a load path LP1 (see FIG. 2) that transfers the load concentrated on the gusset assembly 20 by the retractor 9 along the vehicle width direction through the section cross-sections of the pocket 51, the connecting section 59, and the closed section 57 in the upper portion of the quarter pillar 5.

The seat belt mounting structure 100 of the vehicle body according to the disclosed embodiment may form a load path LP2 (see FIG. 2) that transfers the load concentrated on the gusset assembly 20 by the retractor 9 along the front-rear direction of the vehicle body from the upper portion of the quarter pillar 5 through the roof side 10 and the longitudinal direction roof rails 70.

According to the seat belt mounting structure 100 of the vehicle body according to the disclosed embodiment, the mounting strength of the seat belt assembly 8 mounted on the upper portion of the quarter pillar 5 may be strengthened. According to the seat belt mounting structure 100 of the vehicle body according to the disclosed embodiment, the use of reinforcing materials to reinforce the mounting strength of the seat belt assembly 8 may be minimized or eliminated.

According to the seat belt mounting structure 100 of the vehicle body according to the disclosed embodiment, the seat belt assembly 8 may be mounted on the upper portion of the quarter pillar 5 in a vehicle to which a ramp device for the vulnerable is applied.

According to the seat belt mounting structure 100 of the vehicle body according to the disclosed embodiment, a wheelchair passenger riding in the vehicle may easily wear the seat belt 8a.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A seat belt mounting structure for a vehicle body, the seat belt mounting structure comprising:
a roof side connected to a quarter pillar upper portion of a quarter pillar positioned on a vehicle body side of the vehicle body;
a gusset assembly connected to a pillar connecting portion of the roof side to mount a retractor of a seat belt assembly; and
a transverse direction roof rail connected to the gusset assembly along a vehicle width direction.

2. The seat belt mounting structure of claim 1, further comprising:
longitudinal direction roof rails that are arranged parallel to a front-rear direction of the vehicle body on a vehicle body upper portion of the vehicle body and are connected to the gusset assembly and the transverse direction roof rail.

3. The seat belt mounting structure of claim 2, further comprising:
a joint bracket connected to the gusset assembly, the transverse direction roof rail and the longitudinal direction roof rails.

4. The seat belt mounting structure of claim 3, wherein a pocket for mounting the retractor is formed in the gusset assembly.

5. The seat belt mounting structure of claim 4, wherein:
a closed section is formed between the gusset assembly, the transverse direction roof rail and the joint bracket, which are joined together, and
the closed section is connected to the pocket along the vehicle width direction.

6. A seat belt mounting structure for a vehicle body, the seat belt mounting structure comprising:
a roof side connected to a quarter pillar upper portion of a quarter pillar positioned on a vehicle body side of the vehicle body;
a gusset assembly comprising:
a main gusset unit connected to a pillar connecting portion of the roof side to mount a retractor of a seat belt assembly; and
an extension gusset unit connected to the main gusset unit along a vehicle width direction;
a transverse direction roof rail connected to the extension gusset unit along the vehicle width direction; and
longitudinal direction roof rails arranged parallel to a front-rear direction of the vehicle body on a vehicle body upper portion of the vehicle body and connected to the extension gusset unit and the transverse direction roof rail.

7. The seat belt mounting structure of claim 6, further comprising:
a joint bracket connected to the extension gusset unit, the transverse direction roof rail and the longitudinal direction roof rails.

8. The seat belt mounting structure of claim 6, wherein the main gusset unit comprises:
a lower gusset member connected to the pillar connecting portion and connected to the retractor; and
an upper gusset member connected to the pillar connecting portion and connected to a lower gusset member upper portion of the lower gusset member.

9. The seat belt mounting structure of claim 8, wherein the extension gusset unit comprises:
a lower extension member connected to the lower gusset member along the vehicle width direction, and connected to the longitudinal direction roof rails and the transverse direction roof rail; and
an upper extension member connected to the upper gusset member and the lower extension member along the vehicle width direction.

10. The seat belt mounting structure of claim 9, wherein:
a pocket is formed between the lower gusset member and the upper gusset member, and between the lower extension member and the upper extension member.

11. The seat belt mounting structure of claim 10, further comprising:
a joint bracket connected to the lower extension member, the transverse direction roof rail and the longitudinal direction roof rails.

12. The seat belt mounting structure of claim 10, wherein the retractor is disposed in the pocket through a mount hole formed in the lower gusset member, and connected to an edge of the mount hole.

13. The seat belt mounting structure of claim 9, wherein:
a connection portion of the lower gusset member and the lower extension member is formed as a gusset overlapping portion; and
a connecting portion of the lower extension member connected to the longitudinal direction roof rails and the transverse direction roof rail is formed as a roof rail overlapping portion.

14. The seat belt mounting structure of claim 13, wherein the retractor is disposed in a mount hole formed in the lower gusset member and is mounted to the lower gusset member and the gusset overlapping portion along an edge portion of the mount hole.

15. The seat belt mounting structure of claim 10, wherein:
a joint bracket is connected to the lower extension member, the transverse direction roof rail, and the longitudinal direction roof rails;
a first closed section is formed between the lower extension member, the transverse direction roof rail and the joint bracket, which are joined together; and
a second closed section is connected to the pocket along the vehicle width direction.

16. The seat belt mounting structure of claim 9, wherein each of the longitudinal direction roof rails comprises:
a first roof rail member connected to a front roof rail disposed along the vehicle width direction at a front of both sides of the vehicle body; and
a second roof rail member connected to a rear roof rail disposed along the vehicle width direction at a rear of both sides of the vehicle body.

17. The seat belt mounting structure of claim 16, wherein each of the first roof rail member and the second roof rail member comprises:
rail forming parts formed on free end portions facing each other and connected to a connecting portion of the lower extension member and the transverse direction roof rail.

18. The seat belt mounting structure of claim 7, wherein:
the roof side, the gusset assembly, the transverse direction roof rail, the longitudinal direction roof rails, and the joint bracket are connected to a roof panel.

19. A seat belt mounting structure, the seat belt mounting structure comprising:
a roof side connected to a quarter pillar upper portion of a quarter pillar positioned on a side of a vehicle body;
a gusset assembly connected to a pillar connecting portion of the roof side to mount a retractor of a seat belt assembly;
a transverse direction roof rail connected to the gusset assembly along a vehicle width direction;
longitudinal direction roof rails arranged parallel to a front-rear direction of the vehicle body on a vehicle body upper portion of the vehicle body and are connected to the gusset assembly and the transverse direction roof rail; and
a joint bracket connected to the gusset assembly, the transverse direction roof rail and the longitudinal direction roof rails.

20. The seat belt mounting structure of claim 19, wherein a pocket for mounting the retractor is formed in the gusset assembly.
